(19) United States
(12) Patent Application Publication
(10) Pub. No.: US 2024/0217246 A1
(43) Pub. Date: Jul. 4, 2024

(54) FABRIC PRINTING METHOD

(71) Applicant: Konica Minolta. Inc., Tokyo (JP)

(72) Inventors: Kenichi ONAKA, Tokyo (JP); Ken NITO, Tokyo (JP)

(21) Appl. No.: 18/537,038

(22) Filed: Dec. 12, 2023

(30) Foreign Application Priority Data
Dec. 23, 2022 (JP) 2022-206740

(51) Int. Cl. B41J 3/407; B41J 2/21

(52) U.S. Cl. CPC B41J 3/4078; B41J 2/21

(57) ABSTRACT

A fabric printing method includes, first coloring ink applying in which a coloring ink containing a coloring agent is applied to a fabric; second clear ink applying in which a clear ink containing a resin is applied to the fabric so as to overlap with the coloring ink applied in the first coloring ink applying; and third coloring ink applying in which the coloring ink containing the coloring agent is applied to the fabric so as to overlap with the clear ink applied in the second clear ink applying.

### CROSS-REFERENCE TO RELATED APPLICATIONS

The entire disclosure of Japanese Patent Application No. 2022-206740, filed on Dec. 23, 2022, including description, claims, drawings and abstract is incorporated herein by reference.

### BACKGROUND

### Technical Field

The present invention relates to a fabric printing method. More specifically, the present invention relates to a fabric printing method capable of forming an image excellent in wet friction color fastness, and the like.

### Description of Related Art

As a fabric printing method, a technology is known in which a coloring ink containing a coloring agent and a clear ink containing a resin are applied to a fabric to form an image. For example, Japanese Unexamined Patent Publication No. 2017-132946 discloses a technology in which a coloring ink (coloring ink composition) and a clear ink (clear ink composition) are applied to a fabric, both ink being in a wet state. In addition, Japanese Unexamined Patent Publication No. 2005-320663 discloses a technology of applying a clear ink (treatment liquid B) onto an image formed with a coloring ink (ink). In these related arts, the application of the coloring ink and the application of the same type of clear ink are performed once each.

In a case where printing is performed according to these conventional techniques, there are problems in that the fixing property of the coloring agent to the fabric is low and the wet friction color fastness (color fastness to rubbing in the presence of water) of the image is not sufficient.

### SUMMARY

The present invention has been made in view of the above problems and circumstances. An object to be achieved by the present invention is to provide a fabric printing method capable of forming an image having excellent wet friction color fastness, and a printed fabric on which an image having excellent wet friction color fastness is formed.

In order to achieve the above objects, the inventors of the present invention examined a cause of the above objects. As a result, the present inventors have found that an image having excellent wet friction color fastness can be formed by improving the step of applying a coloring ink and a clear ink, and thus the present invention has been achieved.

That is, the aforementioned problem regarding the present invention is solved by the following means.

According to one aspect of the present invention a fabric printing method includes: first coloring ink applying in which a coloring ink containing a coloring agent is applied to a fabric; second clear ink applying in which a clear ink containing a resin is applied to the fabric so as to overlap with the coloring ink applied in the first coloring ink applying; and third coloring ink applying in which the coloring ink containing the coloring agent is applied to the fabric so as to overlap with the clear ink applied in the second clear ink applying.

According to another aspect, a fabric printing method includes: first clear ink applying in which a clear ink containing a resin is applied to a fabric; second coloring ink applying in which coloring ink containing a coloring agent is applied to the fabric so as to overlap with the clear ink applied in the first clear ink applying; and third clear ink applying in which the clear ink is applied to the fabric so as to overlap with the coloring ink applied in the second coloring ink applying.

According to another aspect, a fabric printing method includes: coloring ink applying in which a coloring ink containing a coloring agent is applied to a fabric; clear ink applying in which a clear ink containing a resin is applied to the fabric; and performing one of the coloring ink applying or the clear ink applying, performing the other applying after the one applying, and performing the one applying again after the other applying so as to overlap the coloring ink and the clear ink.

### BRIEF DESCRIPTION OF THE DRAWINGS

The advantages and features provided by one or more embodiments of the invention will become more fully understood from the detailed description given hereinafter and the appended drawings which are given by way of illustration only, and thus are not intended as a definition of the limits of the present invention, and wherein:

FIG. 1 is a schematic top view showing an example of a fabric printing apparatus applicable to the fabric printing method of the present invention.

### DETAILED DESCRIPTION OF EMBODIMENTS

As one embodiment, the fabric printing method according to the embodiment of the present invention includes a first coloring ink applying step, a second clear ink applying step, and a third coloring ink applying step. In the first coloring ink applying step, a coloring ink containing a coloring agent is applied to fabric. In the second clear ink applying step, a clear ink containing a resin is applied to the fabric so as to be overlapped on the coloring ink applied in the first coloring ink applying step. In the third coloring ink applying step, a coloring ink containing a coloring agent is applied to the fabric so as to be overlapped on the clear ink applied in the second clear ink applying step.

In the above embodiment, it is preferable to further include a fourth clear ink applying step. In the fourth clear ink applying step, a clear ink containing a resin is applied to the fabric so as to be overlapped on the coloring ink applied in the third coloring ink applying step. As a result, the coloring agent contained in the coloring ink and the resin contained in the clear ink are more likely to react or fuse, and the wet friction color fastness is further improved.

In the above embodiment, it is preferable that the coloring ink to be applied in the first coloring ink applying step and the coloring ink to be applied in the third coloring ink applying step are the same coloring ink. It is also preferable that the coloring ink is applied dividing the amount between at least the first coloring ink applying step and the third coloring ink applying step. As a result, the coloring agent contained in the coloring ink and the resin contained in the clear ink are more likely to react or fuse, and the wet friction color fastness is further improved.

In the above embodiment, it is preferable that the clear ink to be applied in the second clear ink applying step and the clear ink to be applied in the fourth clear ink applying step are the same clear ink. It is also preferable that the clear ink is applied dividing the amount between at least the second clear ink applying step and the fourth clear ink applying step. As a result, the coloring agent contained in the coloring ink and the resin contained in the clear ink are more likely to react or fuse, and the wet friction color fastness is further improved.

In one embodiment, the fabric printing method of the present invention includes a first clear ink applying step, a second coloring ink applying step, and a third clear ink applying step. In the first clear ink applying step, the clear ink containing the resin is applied to the fabric. In the second coloring ink applying step, the coloring ink containing the coloring agent is applied to the fabric so as to overlap the clear ink applied in the first clear ink applying step. In the third clear ink applying step, the clear ink is applied to the fabric so as to be overlapped on the coloring ink applied in the second coloring ink applying step.

In the above embodiment, it is preferable that the method further includes a fourth coloring ink applying step. In the fourth coloring ink applying step, a coloring ink containing a coloring agent is applied to the fabric so as to be overlapped on the clear ink applied in the third clear ink applying step. As a result, the coloring agent contained in the coloring ink and the resin contained in the clear ink are more likely to react or fuse, and the wet friction color fastness is further improved.

In the embodiment, it is preferable that the clear ink is applied by dividing the amount at least between the first clear ink applying step and the third clear ink applying step. As a result, the coloring agent contained in the coloring ink and the resin contained in the clear ink are more likely to react or fuse, and the wet friction color fastness is further improved.

In the above embodiment, it is preferable that the coloring ink to be applied in the second coloring ink applying step and the coloring ink to be applied in the fourth coloring ink applying step are the same coloring ink. It is also preferable that the coloring ink is applied dividing the amount at least between the second coloring ink applying step and the fourth coloring ink applying step. As a result, the coloring agent contained in the coloring ink and the resin contained in the clear ink are more likely to react or fuse, and the wet friction color fastness is further improved.

As one embodiment, the fabric printing method according to the present invention includes a coloring ink applying step and a clear ink applying step. In the coloring ink applying step, the coloring ink containing the coloring agent is applied to the fabric. In the clear ink applying step, the clear ink containing the resin is applied to the fabric. Further, according to the present embodiment, the coloring ink and the clear ink are overlapped by performing one of the coloring ink applying step and the clear ink applying step, performing the other step, and performing the one step again after the other step.

In the fabric printing method of the present invention, it is preferable that the application of the coloring ink and the application of the clear ink are performed wet-on-wet. As a result, the coloring agent contained in the coloring ink and the resin contained in the clear ink are more likely to react or fuse, and the wet friction color fastness is further improved.

In the fabric printing method of the present invention, it is preferable that the application of the coloring ink and the application of the clear ink are performed by an inkjet method. From the viewpoint of being able to form a fine image, the inkjet method is preferable. The inkjet method is also preferable from the viewpoint of being suitable for wet-on-wet application of ink.

In the fabric printing method of the present invention, it is preferable that a content of the resin in any of the clear inks is in a range of 1 to 20% by mass. Thus, the performance of fixing the coloring agent and the ejection property in the case of application by the inkjet method become good.

The fabric printing method according to the embodiment of the present invention preferably has a pretreatment step of applying a pretreatment liquid containing an aggregation agent. In a case where the aggregation agent is applied to the fabric, the coloring agent aggregates and is easily fixed to the fabric, and thus the wet friction color fastness is further improved. In addition, since the aggregation agent is applied to the fabric, the pinning property of the coloring ink in a case where the coloring ink is applied by an inkjet method is also improved.

In the fabric printing method of the present invention, it is preferable that the aggregation agent is a water-soluble cationic resin. Thus, the effect of the pretreatment step becomes more improved.

In the fabric printing method of the present invention, it is preferable that any of the clear inks contain a water-soluble cationic resin. Thus, the wet friction color fastness is further improved.

In the fabric printing method of the present invention, it is preferable that any of the clear inks and any of the coloring inks have a viscosity at 25° C. in a range of 3 to 12 mPa·s. Thus, the ejection property in the case of application by an inkjet method becomes favorable.

In the fabric printing method of the present invention, it is preferable that any of the coloring inks contain the resin. Thus, due to the interaction between the resin contained in the coloring ink and the resin contained in the clear ink, the wet friction color fastness is easily improved.

The printed fabric of the present invention has at least one of a portion where the dried clear ink portion is sandwiched between the dried coloring ink portions in the vertical cross section and a portion where the dried coloring ink portion is sandwiched between the dried clear ink portions of the same kind in the vertical cross section.

Hereinafter, the present invention, constituent elements thereof, and modes and aspects for carrying out the present invention will be described in detail. In the present application, “-” or “to” is used to mean that numerical values described before and after “-” or “to” are included as a lower limit value and an upper limit value.

Hereinafter, in a case where the coloring ink and the clear ink are not distinguished from each other, these are also referred to simply as “ink”.

### [Outline of Fabric Printing Method] (Embodiment Example 1)

As one embodiment, the fabric printing method according to the embodiment of the present invention includes a first coloring ink applying step, a second clear ink applying step, and a third coloring ink applying step. In the first coloring ink applying step, a coloring ink containing a coloring agent is applied to the fabric. In the second clear ink applying step, a clear ink containing a resin is applied to the fabric so as to be overlapped on the coloring ink applied in the first coloring ink applying step. In the third coloring ink applying step, a coloring ink containing a coloring agent is applied to the fabric so as to be overlapped on the clear ink applied in the second clear ink applying step. In the case of the above-described embodiment, the coloring ink applied in the first coloring ink applying step and the coloring ink applied in the third coloring ink applying step may be the same or different from each other.

The term “applying so as to be overlapped” refers to applying ink so that at least a part of a region of a dot of ink applied later overlaps a region of a dot of ink applied earlier when an ink application surface of the fabric is viewed from above.

In the above embodiment, it is preferable to further include a fourth clear ink applying step. In the fourth clear ink applying step, a clear ink containing a resin is applied to the fabric so as to be overlapped on the coloring ink applied in the third coloring ink applying step. As a result, the coloring agent contained in the coloring ink and the resin contained in the clear ink are more likely to react or fuse, and the wet friction color fastness is further improved. In the case of the above-described embodiment, the clear ink applied in the second clear ink applying step and the clear ink applied in the fourth clear ink applying step may be the same or different from each other.

In the above-described embodiment, it is preferable that the coloring ink to be applied in the first coloring ink applying step and the coloring ink to be applied in the third coloring ink applying step are the same coloring ink. It is also preferable that the coloring ink is applied dividing the amount between at least the first coloring ink applying step and the third coloring ink applying step. As a result, the coloring agent contained in the coloring ink and the resin contained in the clear ink are more likely to react or fuse, and the wet friction color fastness is further improved. In the case of the above-described embodiment, the coloring ink applied in the first coloring ink applying step and the coloring ink applied in the third coloring ink applying step are the same.

The phrase “dividing the amount” is not limited to dividing an amount into equal amounts, and the amount may or may not be an equal amount.

In the above embodiment, it is preferable that the clear ink to be applied in the second clear ink applying step and the clear ink to be applied in the fourth clear ink applying step are the same clear ink. It is also preferable that the clear ink is applied dividing the amount between at least the second clear ink applying step and the fourth clear ink applying step. As a result, the coloring agent contained in the coloring ink and the resin contained in the clear ink are more likely to react or fuse, and the wet friction color fastness is further improved. In the case of the above-described embodiment, the clear ink applied in the second clear ink applying step and the clear ink applied in the fourth clear ink applying step are the same.

In the above-described embodiment, after the fourth clear ink applying step, the coloring ink applying step and the clear ink applying step may be performed any number of times. As the number of times of the coloring ink applying step or the clear ink applying step is increased, the coloring agent contained in the coloring ink and the resin contained in the clear ink are more easily reacted or fused, and the wet friction color fastness is further improved.

In the above-described embodiment, the first coloring ink applying step and the second clear ink applying step do not need to be continuously performed, and the coloring ink applying step may be further performed therebetween. The same applies if a process is performed between other steps. That is, the above-described embodiment is not limited to the case where the application of the coloring ink and the application of the clear ink to the same place are alternately performed.

### Embodiment Example 2

In one embodiment, the fabric printing method of the present invention includes a first clear ink applying step, a second coloring ink applying step, and a third clear ink applying step. In the first clear ink applying step, the clear ink containing the resin is applied to the fabric. In the second coloring ink applying step, the coloring ink containing the coloring agent is applied to the fabric so as to overlap the clear ink applied in the first clear ink applying step. In the third clear ink applying step, the clear ink is applied to the fabric so as to be overlapped on the coloring ink applied in the second coloring ink applying step. In the case of the above-described embodiment, the clear ink applied in the first clear ink applying step and the clear ink applied in the third clear ink applying step are the same.

In the above-described embodiment, it is preferable that the method further includes a fourth coloring ink applying step. In the fourth coloring ink applying step, a coloring ink containing a coloring agent is applied to the fabric so as to be overlapped on the clear ink applied in the third clear ink applying step. As a result, the coloring agent contained in the coloring ink and the resin contained in the clear ink are more likely to react or fuse, and the wet friction color fastness is further improved. In the case of the above-described embodiment, the coloring ink applied in the second coloring ink applying step and the coloring ink applied in the fourth coloring ink applying step may be the same or different from each other.

In the embodiment, it is preferable that the clear ink is applied by dividing the amount at least between the first clear ink applying step and the third clear ink applying step. As a result, the coloring agent contained in the coloring ink and the resin contained in the clear ink are more likely to react or fuse, and the wet friction color fastness is further improved. In the case of the above-described embodiment, the clear ink applied in the first clear ink applying step and the clear ink applied in the third clear ink applying step are the same.

In the above-described embodiment, it is preferable that the coloring ink to be applied in the second coloring ink applying step and the coloring ink to be applied in the fourth coloring ink applying step are the same coloring ink. It is also preferable that the coloring ink is applied dividing the amount at least between the second coloring ink applying step and the fourth coloring ink applying step. As a result, the coloring agent contained in the coloring ink and the resin contained in the clear ink are more likely to react or fuse, and the wet friction color fastness is further improved. In the case of the above-described embodiment, the coloring ink applied in the second coloring ink applying step and the coloring ink applied in the fourth coloring ink applying step are the same.

In the above-described embodiment, after the fourth coloring ink applying step, the clear ink applying step and the coloring ink applying step may be performed any number of times. As the number of times of the coloring ink applying step or the clear ink applying step is increased, the coloring agent contained in the coloring ink and the resin contained in the clear ink are more easily reacted or fused, and the wet friction color fastness is further improved.

In the above-described embodiment, the first clear ink applying step and the second coloring ink applying step do not need to be continuously performed, and the clear ink applying step may be further performed therebetween. The same applies if a process is performed between other steps. That is, the above-described embodiment is not limited to the case where the application of the clear ink and the application of the coloring ink to the same place are alternately performed.

### Embodiment Example 3

As one embodiment, the fabric printing method according to the present invention includes a coloring ink applying step and a clear ink applying step. In the coloring ink applying step, the coloring ink containing the coloring agent is applied to the fabric. In the clear ink applying step, the clear ink containing the resin is applied to the fabric. Further, according to the present embodiment, the coloring ink and the clear ink are overlapped by performing one of the coloring ink applying step and the clear ink applying step, performing the other step, and performing the one step again after the other step.

In the above-described embodiment, the other step may be performed again after the one step performed again, and this operation may be repeated any number of times. As the number of times of the coloring ink applying step or the clear ink applying step is increased, the coloring agent contained in the coloring ink and the resin contained in the clear ink are more easily reacted or fused, and the wet friction color fastness is further improved.

In the above-described embodiment, the one step and the other step do not need to be continuously performed, and a coloring ink applying step or a clear ink applying step may be further performed therebetween. That is, the above-described embodiment is not limited to the case where the application of the coloring ink and the application of the clear ink to the same place are alternately performed.

### [Fabric]

The fabric according to the present invention is not particularly limited. As the fabric, for example, a fabric containing natural fibers (including natural cellulose fibers, hemp, wool, silk, and the like), synthetic cellulose fibers (including regenerated cellulose fibers such as rayon and semi-synthetic cellulose fibers such as acetate), vinylon fibers, nylon fibers, acrylic fibers, polyurethane fibers, polyester fibers, or the like can be used.

The fabric may be any form of these fibers such as a woven fabric, a nonwoven fabric, or a knit fabric. Furthermore, the fabric may be a blended woven fabric or a blended nonwoven fabric of two or more kinds of fibers.

### [Coloring Ink]

The coloring ink according to the present invention is characterized by containing a coloring agent, and may further contain a solvent, a resin, and the like.

### (Coloring Agent)

Examples of the coloring agent include a pigment and a dye. From the viewpoint of further enhancing the dispersion stability of the coloring ink and forming an image having high weather resistance, the coloring agent is preferably a pigment.

As the pigment, an organic pigment or an inorganic pigment such as titanium oxide can be preferably used. The pigment is generally anionic. The pigment contained in the coloring ink may be only one kind or two or more kinds.

Examples of the organic pigments include azo, azomethine, methine, diphenylmethane, triphenylmethane, quinacridone, anthraquinone, perylene, indigo, quinophthalone, isoindolinone, isoindoline, azine, oxazine, thiazine, dioxazine, thiazole, phthalocyanine, diketopyrrolopyrrole and the like.

Examples of the organic pigment for magenta or red include C. I. Pigment Red 2, C. I. Pigment Red 3, C. I. Pigment Red 5, C. I. Pigment Red 6, C. I. Pigment Red 7, C. I. Pigment Red 15, C. I. Pigment Red 16, C. I. Pigment Red 48:1, C. I. Pigment Red 53:1, C. I. Pigment Red 57:1, C. I. Pigment Red 122, C. I. Pigment Red 123, C. I. Pigment Red 139, C. I. Pigment Red 144, C. I. Pigment Red 149, C. I. Pigment Red 166, C. I. Pigment Red 177, C. I. Pigment Red 178, C. I. Pigment Red 202, C. I. Pigment Red 222, and C. I. Pigment Violet 19.

Examples of organic pigments for orange or yellow include C. I. Pigment Orange 31, C. I. Pigment Orange 43, C. I. Pigment Yellow 12, C. I. Pigment Yellow 13, C. I. Pigment Yellow 14, C. I. Pigment Yellow 15, C. I. Pigment Yellow 15:3, C. I. Pigment Yellow 17, C. I. Pigment Yellow 74, C. I. Pigment Yellow 93, C. I. Pigment Yellow 128, C. I. Pigment Yellow 94, C. I. Pigment Yellow 138, and C. I. Pigment Yellow 155.

Examples of the organic pigment for green or cyan include C. I. Pigment Blue 15, C. I. Pigment Blue 15:2, C. I. Pigment Blue 15:3, C. I. Pigment Blue 16, C. I. Pigment Blue 60, and C. I. Pigment Green 7.

Examples of the organic pigment for black include C. I. Pigment Black 1, C. I. Pigment Black 6, and C. I. Pigment Black 7.

Titanium oxide has three crystal forms of an anatase type, a rutile type, and a brookite type, and generally used titanium oxide can be roughly classified into the anatase type and the rutile type. The titanium oxide is not particularly limited, but is preferably a rutile type having a large refractive index and high concealability. Specific examples of titanium oxides include TR series manufactured by Fuji Titanium Industry Co., Ltd., the JR series manufactured by Tayca Corporation, and Tipaque manufactured by Ishihara Sangyo Kaisha, Ltd.

The pigment may be a self-dispersible pigment. The self-dispersible pigment is obtained by modifying the surface of a pigment particle with a group having a hydrophilic group. The self-dispersing pigment has pigment particles and a hydrophilic group bonded to the surface of the pigment particles.

Examples of the hydrophilic group include a carboxy group, a sulfonic acid group, and a phosphorus-containing group. Examples of the phosphorus-containing group include a phosphoric acid group, a phosphonic acid group, a phosphinic acid group, a phosphite group, and a phosphate group.

Examples of commercially available products of the self-dispersing pigment include Cab-O-Jet (Registered Trademark) 200K, 250C, 260M, and 270 V (sulfonic acid group-containing self-dispersing pigment), Cab-O-Jet (Registered Trademark) 300K (carboxylic acid group-containing self-dispersing pigment), and Cab-O-Jet (Registered Trademark) 400K, 450C, 465M, 470 V, and 480 V (phosphoric acid group-containing self-dispersing pigment), all of which are manufactured by Cabot Corporation.

The content of the coloring agent in the coloring ink is preferably in a range of 0.1% to 10% by mass and more preferably in a range of 0.3% to 5% by mass with respect to the total amount of the coloring ink. When the content of the coloring agent is 0.1% by mass or more, a necessary amount of the coloring agent can be applied without excessively increasing the application amount of the coloring ink. When the content of the coloring agent is 10% by mass or less, the coloring agent is easily dispersed in a solvent, and the coatability of the coloring ink becomes good.

### (Solvent)

The solvent that the coloring ink may contain is not particularly limited, and an organic solvent or water can be used. The solvent contained in the coloring ink may be only one kind or two or more kinds.

The water contained in the coloring ink is not particularly limited, and ion-exchanged water, distilled water, pure water, or the like can be used. The content of water in the coloring ink is preferably in a range of 30 to 70% by mass with respect to the total amount of the coloring ink.

Among examples of the organic solvent contained in the coloring ink, a water-soluble organic solvent is preferable.

Examples of the water-soluble organic solvent include monohydric alcohols, polyhydric alcohols, polyhydric alcohol ethers, amines, amides, heterocycles, sulfoxides, and sulfones. Examples of monohydric alcohols include methanol, ethanol, propanol, pentanol, hexanol, cyclohexanol, and benzyl alcohol. Examples of the polyhydric alcohols include ethylene glycol, diethylene glycol, triethylene glycol, tetraethylene glycol, polyethylene glycol, propylene glycol, dipropylene glycol, tripropylene glycol, polypropylene glycol, glycerin, butylenes glycol, hexanediol, pentanediol, hexanetriol, thiodiglycol, a compound represented by the following General Formula (1),1,2-butanediol, 1,3-butanediol, 1,2-pentanediol, 1,2-hexanediol, 1,6-hexanediol, 1,2-heptanediol and trimethylolpropane. Examples of the polyhydric alcohol ethers include ethylene glycol monomethyl ether, ethylene glycol monoethyl ether, ethylene glycol monobutyl ether, ethylene glycol monophenyl ether, diethylene glycol monomethyl ether, diethylene glycol monoethyl ether, diethylene glycol monobutyl ether, diethylene glycol dimethyl ether, propylene glycol monomethyl ether, propylene glycol monoethyl ether, triethylene glycol monomethyl ether, tetraethylene glycol monomethyl ether, and tripropylene glycol monoethyl ether. Examples of the amines include ethanol amine, N-ethyldiethanolamine, morpholine, N-ethylmorpholine, ethylene diamine, diethylene diamine and triethylenetetramine. Examples of the amides include formamide, N,N-dimethylformamide, and N,N-dimethylacetamide. Examples of the heterocyclic rings include 2-pyrrolidone, N-methyl-2-pyrrolidone, N-cyclohexyl-2-pyrrolidone, 2-oxazolidone and 1,3-dimethyl-2-imidazolidine. Examples of the sulfoxides include dimethyl sulfoxide. Examples of the sulfones include sulfolane.

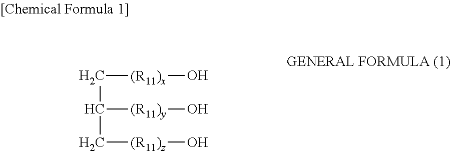

[In general formula (1), R₁₁ all represent an ethylene glycol group or a propylene glycol group. x, y, and z are all positive integers, and x+y+z=3 to 30]

The content of the organic solvent in the coloring ink is preferably in a range of 20 to 50% by mass with respect to the total amount of the coloring ink.

### (Resin)

Furthermore, the coloring ink preferably contains a resin. In a case where a plurality of kinds of coloring inks are used, it is preferable that any of the coloring inks contain the resin.

As the resin contained in the coloring ink, an anionic resin is preferable. The anionic resin functions as a binder for the coloring agent. Due to the fact that the coloring ink contains an anionic resin, the wet friction color fastness is easily improved due to the interaction with the resin contained in the clear ink.

As the anionic resin, for example, polyester, polyurethane, polyacryl, polymethacryl or the like having an acidic group such as a carboxy group, a sulfonyl group, a phosphorus-containing group (a phosphoric acid group or a phosphonic acid group) or the like can be used.

As the anionic resin, for example, the following products can be used.
ACRYSET EMN series manufactured by Nippon Shokubai Co., Ltd
NeoCryl series manufactured by Kusumoto Chemicals, Ltd
JONCRYL series manufactured by BASF SE
TAKELAC series manufactured by Mitsui Chemicals, Inc
HUX series manufactured by ADEKA CORPORATION
Evafanol series manufactured by Nicca Chemical Co., Ltd
SUPERFLEX SERIES manufactured by DKS

The resin contained in the coloring ink may be only one type or two or more types.

The content (solid content) of the resin in the coloring ink is preferably in a range of 5 to 15% by mass with respect to the total amount of the coloring ink.

### (Other Components)

The coloring ink may further contain components other than those described above, if necessary, as long as the effects of the present invention are not impaired. Examples of other components include a surfactant, a preservative, a pH adjuster, and the like.

As the surfactant, any of an anionic surfactant, a cationic surfactant, a nonionic surfactant and an amphoteric surfactant may be used.

Examples of preservatives include aromatic halogen compounds (e.g., PreventolCMK), methylene dithiocyanate, halogen-containing nitrogen-sulfur compounds, 1,2-benzisothiazolin-3-one (e.g., PROXEL GXL), and the like.

Examples of the pH adjuster include citric acid, sodium citrate, hydrochloric acid, and sodium hydroxide.

### (Viscosity)

The viscosity of the coloring ink at 25° C. can be appropriately adjusted depending on the application method to the fabric. For example, in a case where the coloring ink is applied by an inkjet method, from the viewpoint of jettability, the viscosity of the coloring ink is preferably in a range of 3 to 12 mPa·s. In addition, the viscosity of the coloring ink can be measured with an E type viscometer.

### [Clear Ink]

The clear ink according to the present invention is characterized by containing a resin, and may further contain a solvent and the like.

### (Resin)

Furthermore, the clear ink preferably contains a resin. In a case where a plurality of kinds of clear inks are used, it is preferable that any of the clear inks contain the resin.

The resin contained in the clear ink may be either a cationic resin or an anionic resin.

When the cationic resin is contained in the clear ink, reactivity or fusibility with the coloring agent contained in the coloring ink is improved, and the wet friction color fastness is easily improved. In addition, particularly in a case where the coloring ink contains an anionic resin, the wet friction color fastness is further improved by adding a cationic resin to the clear ink. This is because the anionic resin and the cationic resin are crosslinked to each other, the molecular weight becomes pseudo-large, and an intermolecular force becomes large, with the result that a force for fixing the coloring agent to the fabric becomes large. In the present invention, as described above, since the coloring agent contained in the coloring ink and the resin contained in the clear ink easily react or fuse with each other, this effect is particularly easily exhibited.

Furthermore, by including a cationic resin in the clear ink, it is also possible to reduce the bending rigidity value of the fabric by alleviating the entanglement between the fibers of the fabric.

By containing an anionic resin in the clear ink, particularly in a case where the coloring ink contains an anionic resin, it is possible to improve the wet friction color fastness and the color developing properties. This is because the volume concentration of the coloring agent in the entirety of the coloring ink and the clear ink is reduced, and thus the dispersibility of the coloring agent is improved.

As described above, the resin contained in the clear ink may be either a cationic resin or an anionic resin. The resin contained in the clear ink is preferably a cationic resin from the viewpoint of more easily improving the wet friction color fastness. Further, the resin contained in the clear ink is particularly preferably a water-soluble cationic resin.

In the present invention, the term “water-soluble” refers to a property of dissolving in water as a solvent at 25° C. in an amount of 1% by mass or more.

As the water-soluble cationic resin, for example, polyallylamine, an allylamine-diallylamine copolymer, polydiallylamine, polymethyldiallylamine, a diallylamine-sulfur dioxide copolymer, a methyldiallylamine-sulfur dioxide copolymer, polyvinylamine, polyethyleneimine, polydiallyldimethylammonium chloride, polydiallylamine amide, and an alkylamine ⋅ ammonia ⋅ epichlorohydrin polycondensate can be used.

As the water-soluble cationic resin, for example, the following products can be used.
RKW series and WEM series manufactured by Taisei Fine Chemical Co., Ltd
Vinyblan 1008, 1028, 2687 manufactured by Nissin Chemical Industry Co. Ltd
Sumifloc FC-A, FC-B, FC-L, FC-373, FC-200, FC-C, FC-E, manufactured by Sumitomo Chemical Co. Ltd
Sanfloc C-450 and C-454 manufactured by Sanyo Chemical Industries, Ltd
Himoloc MP series, E series, and M-966 manufactured by Hymo Corporation
EPOMIN series manufactured by Nippon Shokubai Co., Ltd
CACHIO MASTER SERIES, manufactured by Yokkaichi Chemical Co., Ltd
MPT series manufactured by Mitsubishi Pencil Co., Ltd
PAS series manufactured by Nittobo Medical Co., Ltd
UNISENCE series manufactured by Senka Corporation

The anionic resin that can be contained in the clear ink is the same as that which can be contained in the above-described coloring ink.

The resin contained in the clear ink may be only one type or two or more types.

The content (solid content) of the resin in the clear ink is preferably within a range of 1 to 20% by mass with respect to the total amount of the clear ink. Thus, the performance of fixing the coloring agent and the ejection property in the case of application by the inkjet method become good.

### (Solvent)

The solvent that can be contained in the clear ink is not particularly limited, and an organic solvent or water can be used. The solvent contained in the coloring ink may be only one kind or two or more kinds.

The water and the organic solvent that the clear ink can contain are the same as those that the above-described coloring ink can contain.

The content of water in the clear ink is preferably in a range of 30 to 70% by mass with respect to the total amount of the clear ink.

The content of the organic solvent in the clear ink is preferably within a range of 10 to 50% by mass with respect to the total amount of the clear ink.

### (Other Components)

The clear ink may further contain other components than those described above as necessary to the extent that the effects of the present invention are not impaired. Examples of other components include a surfactant, a preservative, a pH adjuster, and the like, similarly to the coloring ink.

### (Viscosity)

The viscosity of the clear ink at 25° C. can be appropriately adjusted according to the method of applying the clear ink to fabric. For example, in a case where the clear ink is applied by an inkjet method, the viscosity of the clear ink is preferably in a range of 3 to 12 mPa·s from the viewpoint of ejection properties. In addition, the viscosity of the clear ink can be measured with an E type viscometer.

### [Application of Coloring Ink and Clear Ink]

In the fabric printing method of the present invention, it is preferable that the application of the coloring ink and the application of the clear ink are performed wet-on-wet. As a result, the previously applied ink and the subsequently applied ink are easily mixed, and the respective contained components are easily reacted or fused. Thus, an image having more excellent wet friction color fastness can be formed.

In the present invention, the term “wet-on-wet” means that the subsequent ink is applied in a state where 30% by mass or more of the volatile component of the previously applied ink remains on the fabric, or the application of the subsequent ink on the fabric is started within 30 seconds at 40° C. or less from the completion of the application of the previous ink.

As a method of applying the coloring ink and the clear ink to the fabric, known methods can be used without particular limitation. Specifically, a spray method, a mangle method (a pad method or a dipping method), a coating method, an inkjet method, or the like can be used. For example, the coloring ink application process and the clear ink application process are performed by an inkjet method, and the inkjet method is preferable from the viewpoint of being able to form a fine image. The inkjet method is also preferable from the viewpoint of being suitable for wet-on-wet application of ink.

In a case of the inkjet method, the pass method may be any one of a multi-pass method (a serial head method or a scanning method) and a single pass method (a line head method). However, in the fabric printing method of the present invention, a multi-pass method in which the same ink is easily applied again is preferable.

The total application amount of the coloring inks to the same area is not particularly limited, and can be adjusted according to the type of fabric, the image to be formed, the content of the coloring agent in the coloring ink, the required application amount of the coloring agent, and the like.

The total application amount of the clear ink to the same area is not particularly limited and can be adjusted according to the type of fabric, the image to be formed, the resin content in the clear ink, the application amount of the coloring ink, and the like.

In the fabric printing method in which the coloring ink and the clear ink are applied to the fabric, in a case where a large application amount of a coloring agent is required, a large application amount of each ink is required, and thus components of each ink are not easily sufficiently reacted or fusion-bonded. Therefore, in the related art, in such a case, the resin cannot sufficiently fix the coloring agent, and the wet friction color fastness tends to be deteriorated. On the other hand, the fabric printing method of the present invention can sufficiently react or fuse the components of each ink. Therefore, the fabric printing method of the present invention can provide good wet friction color fastness even when forming the image having a portion with a large application amount of the coloring agent (e.g., 0.45 g/m² or more). The fabric printing method of the present invention is particularly effective in this respect as compared with the prior art.

### [Drying Process of Fabric]

The fabric printing method of the present invention preferably includes a fabric drying process after the coloring ink application process and the clear ink application process. Through the drying process, the coloring ink and the clear ink applied to the fabric are fixed to the fabric.

The drying method is not particularly limited, and may be a method using a heater, a warm air dryer, a heating roller, or the like. In particular, it is preferable that both surfaces of the fabric are heated and dried using a hot air dryer and a heater.

The drying temperature is not particularly limited, but is preferably 110° C. or more and more preferably in the range of 130° C. to 180° C. from the viewpoint of sufficiently removing the solvent contained in the applied ink. The drying time depends on the drying temperature, but may be, for example, in a range of 0.5 to 10 minutes.

### [Pretreatment Step]

The fabric printing method according to the embodiment of the present invention preferably has a pretreatment step of applying a pretreatment liquid containing an aggregation agent before the coloring ink applying step and the clear ink applying step.

The term “aggregation agent” refers to a component that can aggregate a coloring agent. In a case where the aggregation agent is applied to the fabric, the coloring agent aggregates and is easily fixed to the fabric, and thus the wet friction color fastness is further improved. In addition, since the aggregation agent is applied to the fabric, the pinning property of the coloring ink in a case where the coloring ink is applied by an inkjet method is also improved.

The aggregation agent is not particularly limited as long as it can aggregate the coloring agent. Typically, since the coloring agent is an anionic component, examples of the aggregation agent include a polyvalent metal salt, a monovalent metal salt, an organic acid, an inorganic acid, a water-soluble cationic resin, and a metal chelate. Among these, the aggregation agent is preferably a water-soluble cationic resin from the viewpoint of more favorable effects.

The water-soluble cationic resin that can be contained in the pretreatment liquid is the same as that which can be contained in the clear ink described above.

The polyvalent metal salt is a compound composed of a polyvalent metal and an acid. The type of the polyvalent metal constituting the polyvalent metal salt is not particularly limited, and examples thereof include calcium, magnesium, aluminum, copper, nickel, tin, barium, iron, chromium, yttrium, zinc, and the like. The acid forming the polyvalent metal salt may be an organic acid or an inorganic acid.

The monovalent metal salt is a compound composed of a monovalent metal and an acid. Examples of the monovalent metal constituting the monovalent metal salt include sodium and potassium. The acid forming the monovalent metal salt may be an organic acid or an inorganic acid.

Examples of the organic acid include formic acid, acetic acid, propionic acid, isobutyric acid, oxalic acid, fumaric acid, malic acid, citric acid, malonic acid, succinic acid, maleic acid, benzoic acid, 2-pyrrolidone-5-carboxylic acid, lactic acid, acrylic acid or a derivative thereof, methacrylic acid or a derivative thereof, acrylamide or a derivative thereof, and a sulfonic acid derivative.

Examples of the inorganic acid include sulfuric acid, hydrochloric acid, nitric acid, phosphoric acid, boric acid, hydrofluoric acid, and carbonic acid.

Examples of metal-chelates include metal-chelates with acetylacetone, methyl acetoacetate, ethyl acetoacetate, ethyl lactate, methyl salicylate or the like having a nitrogen-containing group on a metal such as aluminum, zinc, cadmium, nickel, cobalt, copper, calcium, barium, titanium, manganese, iron, lead, zirconium, chromium, tin, or the like.

The aggregation agent contained in the pretreatment liquid may be only one kind or two or more kinds.

The content of the aggregation agent in the pretreatment liquid is preferably 1 to 10% by mass with respect to the total amount of the pretreatment liquid. When the content of the aggregation agent is 1% by mass or more, the application amount of the pretreatment liquid can be suppressed. When the content of the aggregation agent is 10% by mass or less, the aggregation agent can be uniformly distributed in the pretreatment liquid application region on the fabric.

The pretreatment liquid may contain water, an organic solvent, a surfactant, a preservative, a pH adjuster, and the like, in addition to the aggregation agent, similarly to the clear ink described above.

The viscosity of the pretreatment liquid at 25° C. can be appropriately adjusted depending on the application method to the fabric. For example, in a case where the pretreatment liquid is applied by an inkjet method, from the viewpoint of jettability, the viscosity of the pretreatment liquid is preferably in a range of 3 to 12 mPa s. In addition, the viscosity of the pretreatment liquid can be measured with an E type viscometer.

In the pretreatment step, the pretreatment liquid is applied to the fabric. The region to which the pretreatment liquid is applied may be the entire surface of the fabric, or may be a partial region corresponding to the image to be formed.

As a method of applying the pretreatment liquid to the fabric, known methods can be used without particular limitation. As a method of applying the pretreatment liquid to the fabric, specifically, a spray method, a mangle method (a pad method or a dipping method), a coating method, an inkjet method, or the like can be used.

In a case of the mangle method, the application amount of the pretreatment liquid can be adjusted by immersing the fabric in the pretreatment liquid stored in a bathtub and then squeezing the fabric.

In a case of the inkjet system, liquid droplets of the pretreatment liquid are jetted toward the fabric from an inkjet recording head using an inkjet recording apparatus. The application amount of the pretreatment liquid can be adjusted by the droplet amount or dot density of one liquid.

The amount of the pretreatment liquid to be applied is not particularly limited and can be adjusted according to the content of the aggregation agent in the pretreatment liquid, the amount of the coloring agent to be applied in the coloring ink applying step, and the like.

After applying the pretreatment liquid to the fabric, a drying step may be performed, but it is preferable that the solvent remains. In a case where the drying step is performed, for example, heating and drying using warm air, a hot plate, a heat roller, or the like can be employed. The drying temperature can be set within a range of 100 to 130° C., for example.

### [Fabric Printing Apparatus]

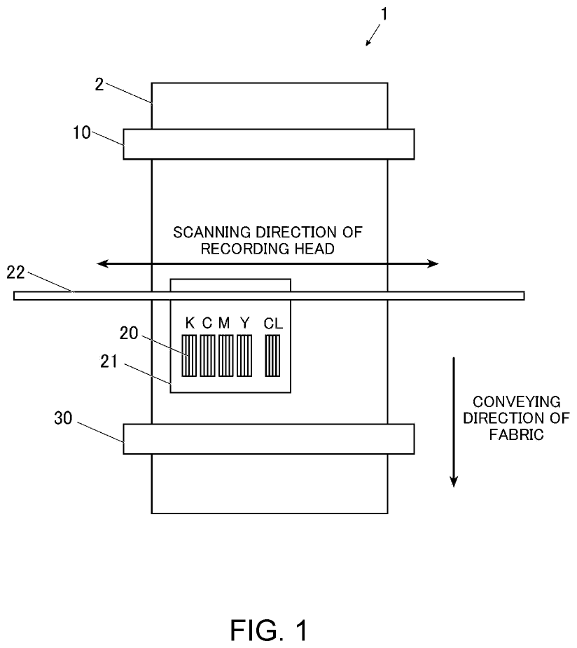

FIG. 1 is a schematic top view showing an example of a fabric printing apparatus applicable to the fabric printing method of the present invention. The fabric printing apparatus 1 illustrated in FIG. 1 is an apparatus capable of applying ink by an inkjet method and a multi-pass method.

The fabric printing apparatus 1 includes a pretreatment liquid applying section 10, a head carriage 21, a guide section 22, and a drying section 30. The head carriage 21 houses the plurality of inkjet recording heads 20. The guide portion 22 is a member for moving the head carriage 21 in the width direction of the fabric 2.

The fabric 2 is conveyed by a conveyance section (not illustrated) such as a conveyance belt.

The pretreatment liquid applying section 10 is located upstream of the inkjet recording head 20 and applies a pretreatment liquid to the fabric 2. The fabric printing apparatus 1 may include a pretreatment liquid drying section (not illustrated) on the downstream of the pretreatment liquid applying section 10.

In the example illustrated in FIG. 1, the head carriage 21 accommodates recording heads for coloring inks (K, C, M, and Y) and a recording head for clear ink (CL) as the plurality of inkjet recording heads 20. By moving the head carriage 21 back and forth in the width direction of the fabric 2, each of the coloring ink and the clear ink can be applied to the same location of the fabric 2 in any order or any number of times. The application of ink may be performed in both the forward path and the return path, or may be performed in only one of the paths. The number of round trips is not particularly limited, and may be appropriately set.

The drying section 30 is located on the downstream of the inkjet recording head 20 and dries the pretreatment liquid and the ink applied to the fabric 2.

### [Printed Fabric]

The printed fabric of the present invention has at least one of a portion where the dried clear ink portion is sandwiched between the dried coloring ink portions in the vertical cross section and a portion where the dried coloring ink portion is sandwiched between the dried clear ink portions of the same kind in the vertical cross section.

The term “vertical cross section” refers to a cross section perpendicular to the surface to which the ink is applied.

The “dried clear ink portion” refers to a portion formed by drying the clear ink. The dry clear ink portion is mainly composed of a non-volatile component such as a resin among the contained components of the clear ink, and may contain a residual solvent.

The “dried coloring ink portion” refers to a portion formed by drying the coloring ink. The dried coloring ink portion is mainly composed of a non-volatile component such as a coloring agent among the components contained in the coloring ink, and may contain a residual solvent.

In the printed fabric according to the embodiment of the present invention, the boundary between the dried coloring ink portion and the dried clear ink portion in the vertical cross section is not clear. In the printed fabric of the present invention, the shades of the dried coloring ink part and the dried clear ink part in a vertical cross section are less and more uniform than in a conventional printed fabric.

Such a printed fabric can be produced by the fabric printing method according to the embodiment of the present invention. The printed fabric may have a dried coloring ink portion and a dried clear ink portion that are overlapped according to the order and the number of times of the coloring ink applying step and the clear ink applying step. The dried coloring ink portion and the dried clear ink portion are overlapped in the thickness direction of the printed fabric.

### EXAMPLE

Hereinafter, the present invention will be specifically described with reference to the Examples, but the present invention is not limited thereto. Note that in the following examples, operations were performed at room temperature (25° C.) unless otherwise specified. In addition, unless otherwise specified, “%”, “ppm”, and “parts” respectively mean “% by mass”, “ppm by mass”, and “parts by mass”.

### 1. Preparation of Pretreatment Liquid, Coloring Ink and Clear Ink

The pretreatment liquid, the coloring ink, and the clear ink were prepared according to the following procedure.

The components described in Table I were mixed to prepare a pretreatment liquid 1-1.

TABLE I

| | | | PRE- |
|---|---|---|---|
| | | | TREATMENT |
| | | | LIQUID 1-1 |
| COMPONENTS | RESIN | MPT-60 | 6.8% |
| | ORGANIC | ETHYLENE | 20% |
| | SOLVENT | GLYCOL | |
| | ORGANIC | PROPYLENE | 10% |
| | SOLVENT | GLYCOL | |
| | ACTIVE AGENT | E1010 | 0.10% |
| | PRESERVATIVE | Proxcel GXL(S) | 0.05% |
| | WATER | ION- | 63.05% |
| | | EXCHANGED | |
| | | WATER | |

| | |
|---|---|
| TOTAL | 100% |

| | |
|---|---|
| VISCOSITY AT 25° C. η | 3.6 mPa · s |

The components described in Table II were mixed to prepare coloring inks 2-1 and 2-2.

TABLE II

| | | | COLORING | COLORING |
|---|---|---|---|---|
| | | | INK 2-1 | INK 2-2 |
| COMPONENTS | PIGMENT | Cab-O-Jet-4637M | 1.5% | 1.5% |
| | DISPERSION | | | |
| | LIQUID | | | |
| | RESIN | EMN-325E | 13.5% | — |
| | RESIN | HA-207 | — | 13.5% |
| | ORGANIC | ETHYLENE GLYCOL | 20% | 20% |
| | SOLVENT | | | |
| | ORGANIC | GLYCERIN | 10% | 10% |
| | SOLVENT | | | |
| | ACTIVE AGENT | E1010 | 0.10% | 0.10% |
| | PRESERVATIVE | Proxcel GXL(S) | 0.05% | 0.05% |
| | WATER | ION-EXCHANGED | 54.85% | 54.85% |
| | | WATER | | |

| | | |
|---|---|---|
| TOTAL | 100% | 100% |

| | | |
|---|---|---|
| VISCOSITY AT 25° C. η | 6.3 mPa · s | 5.9 mPa · s |

The components described in Table III were mixed to prepare clear inks 3-1, 3-2, and 3-3.

TABLE III

| | | | CLEAR | CLEAR | CLEAR |
|---|---|---|---|---|---|
| | | | INK | INK | INK |
| | | | 3-1 | 3-2 | 3-3 |
| COMPONENTS | RESIN | HA-207 | — | — | 10% |
| | RESIN | VINYBLAN 2687 | — | 10% | — |
| | RESIN | UNISENCE FPA100L | 10% | — | — |
| | ORGANIC | ETHYLENE GLYCOL | 20% | 20% | 20% |
| | SOLVENT | | | | |
| | ORGANIC | GLYCERIN | 10% | 10% | 10% |
| | SOLVENT | | | | |
| | ACTIVE AGENT | E1010 | 0.10% | 0.10% | 0.10% |
| | PRESERVATIVE | Proxcel GXL(S) | 0.05% | 0.05% | 0.05% |
| | WATER | ION-EXCHANGED | 59.85% | 59.85% | 59.85% |
| | | WATER | | | |

| | | | |
|---|---|---|---|
| TOTAL | 100% | 100% | 100% |

| | | | |
|---|---|---|---|
| VISCOSITY AT 25° C. η | 5.1 mPa · s | 5.2 mPa · s | 4.8 mPa · s |

Details of the respective components listed in Tables I to III are as follows.

### (Water-Soluble Cationic Resin)

MPT-60: manufactured by Mitsubishi Pencil Co., Ltd
UNISENCE FPA100L: manufactured by Senka Corporation, Polydiallyldimethylammonium chloride (Cationic Resin)
Vinyblan 2687: manufactured by Nissin Chemical Industry Co., Ltd., cationized polyacrylate emulsion (Anionic Resin)
EMN-325E: manufactured by Nippon Shokubai Co., Ltd, acrylic resin, glass transition point-50° C.,
HA-207: manufactured by Nicca Chemical Co., Ltd., urethane resin, glass transition point-50° C.
A-1127: manufactured by Kusumoto Chemicals, Ltd, acrylic resin (Pigment Dispersion Liquid)
Cab-O-Jet-4637M: Cabot Corporation, concentration of pigment 22.9% (Active Agent)
E1010: manufactured by Nissin Chemical Industry Co., Ltd, acetylene glycol-based surfactant (Preservative)
Proxcel GXL(S): manufactured by Lonza K.K.

### 2. Fabric Printing

### Example 1

The pretreatment liquid 1-1, the coloring ink 2-1, and the clear ink 3-1 prepared above were set in a simple printing tester equipped with a KM1024i head as an inkjet head.

Cotton broadcloth 40 (cotton 100%) was prepared as the fabric. Using the simple printing tester, the pretreatment liquid, the coloring ink, and the clear ink were applied to the surface of this fabric in the following order of steps to form the image. The application of each of the pretreatment liquid, the coloring ink, and the clear ink was performed wet-on-wet. In addition, these applications were all performed in the main scanning 540 dpi×sub-scanning 720 dpi by an inkjet method and a multi-pass method. The term “dpi” represents the number of ink droplets (dots) per 2.54 cm. The ejection frequency was set to 22.4 kHz. The image to be formed was an image including a fine line grid, gradation, and a solid portion (the image being 200 mm×200 mm as a whole).

First, the pretreatment liquid was applied in an amount of 30 g/m². Next, the voltage was adjusted and the coloring ink was applied so as to have an application amount of 3.75 g/m². Next, the clear ink was applied so as to have an application amount of 3.75 g/m². The applying step of the coloring ink and the clear ink was repeated such that the applied coloring ink and clear ink are overlapped on each other, and each of the coloring ink and the clear ink was applied eight times.

Thereafter, the fabric was dried at 130° C. for 10 minutes.

### Examples 2 to 10 and Comparative Examples 1 to 3

The fabric printing was performed in the same manner as in Example 1 except that the type of the coloring ink, the application amount of the coloring ink, the type of the clear ink, the application amount of the clear ink, and the order of the coloring ink applying step and the clear ink applying step were changed as shown in Table IV.

### 3. Evaluation of Wet Friction Color Fastness

The wet friction color fastness of the image formed on the fabric was evaluated with a crock meter (friction tester, type I) in accordance with the wetting test of JIS L 0849.

To be specific, the 100 mm×100 mm region of the formed image was rubbed 100 times back and forth with a white cotton cloth for rubbing under the load of 200 g. As the white cotton cloth for rubbing, a white cotton cloth wetted with water to be in a wet state of about 100% was used. After applying friction, color transfer to a white cotton fabric for friction was observed, and wet friction color fastness was evaluated according to the following standards. The evaluation results are as described in Table IV. AA to B are acceptable ranges.

AA: There is almost no color transfer.
A: There is slight color transfer, but the degree is good.
B: Although there is color transfer, it is within an allowable range.
C: There is color transfer, which is beyond the acceptable range.
D: There is significant color transfer, which is beyond the acceptable range.

### 4. Color Density Evaluation

The surface reflectance of the image formed on the fabric was measured with a spectrophotometer (manufactured by X-Rite, Inc), and the K/S value was calculated. The K/S value is an index of the surface color density defined by the following expression. A larger K/S value means a higher color density, and a smaller K/S value means a lower color density.

$$Kubelka - Munk Expression : K / S = {( 1 - R )}^{2} / 2 R$$

(K: absorption coefficient of light, S: Scattering coefficient of light, R: Surface reflectance)

Based on the calculated K/S value, the color density was evaluated according to the following criteria. The evaluation results are as described in Table IV. AA to B are acceptable ranges.
AA: The K/S value was 5.6 or more.
A: The K/S value was 5.0 or more and less than 5.6.
B: The K/S value was 4.4 or more and less than 5.0, which is within an allowable range.
C: The K/S value was 3.8 or more and less than 4.4, which is beyond the allowable range.
D: The K/S value was less than 3.8, which is beyond the allowable range.

TABLE IV

| | COLORING INK | | CLEAR INK | | | EVALUATION | |
|---|---|---|---|---|---|---|---|
| | | APPLI- | | APPLI- | | WET | |
| | | CATION | | CATION | | FRICTION | COLOR |
| | | AMOUNT | | AMOUNT | ORDER OF COLORING INK APPLYING | COLOR | DEN- |
| | TYPE | [g/m²] | TYPE | [g/m²] | STEP AND CLEAR INK APPLYING STEP | FASTNESS | SITY |
| EXAMPLE 1 | 2-1 | 3.75 | 3-1 | 3.75 | (COLORING→CLEAR) × 8 | AA | AA |
| EXAMPLE 2 | 2-1 | 3.75 | 3-1 | 3.75 | (COLORING→CLEAR→CLEAR→COLOR- | AA | AA |
| | | | | | ING) × 4 | | |
| EXAMPLE 3 | 2-1 | 3.75 | 3-1 | 3.75 | (CLEAR→COLORING) × 8 | A | AA |
| EXAMPLE 4 | 2-1 | 3.75 | 3-1 | 3.75 | (CLEAR→COLORING→COLORING→CLEAR) × 4 | AA | AA |
| EXAMPLE 5 | 2-2 | 5 | 3-2 | 5 | (COLORING→CLEAR) × 8 | AA | B |
| EXAMPLE 6 | 2-2 | 5 | 3-2 | 5 | (COLORING→CLEAR→CLEAR→COLOR- | AA | B |
| | | | | | ING→COLORING→CLEAR) × 2 | | |
| EXAMPLE 7 | 2-2 | 5 | 3-2 | 5 | (CLEAR→COLORING) × 6 | A | B |
| EXAMPLE 8 | 2-2 | 5 | 3-2 | 5 | (CLEAR→COLORING→COLOR- | A | B |
| | | | | | ING→CLEAR→CLEAR→COLORING) × 2 | | |
| EXAMPLE 9 | 2-1 | 3.75 | 3-3 | 3.75 | (COLORING→CLEAR) × 8 | B | AA |
| EXAMPLE 10 | 2-1 | 3.75 | 3-3 | 3.75 | (COLORING→CLEAR→CLEAR→COLOR- | B | AA |
| | | | | | ING) × 4 | | |
| COMPARATIVE | 2-1 | 3.75 | 3-1 | 3.75 | (COLORING) × 8→(CLEAR) × 8 | C | B |
| EXAMPLE 1 | | | | | | | |
| COMPARATIVE | 2-2 | 5 | 3-2 | 5 | (COLORING) × 6→(CLEAR) × 6 | D | C |
| EXAMPLE 2 | | | | | | | |
| COMPARATIVE | 2-1 | 5 | 3-3 | 5 | (COLORING) × 6→(CLEAR) × 6 | D | C |
| EXAMPLE 3 | | | | | | | |

The amount described in Table IV is an application amount in one application process. The application amount in this single application process was set by dividing the application amount required for image formation.

In the column of “Order of Coloring Ink Applying Step and Clear Ink Applying Step” of Table IV, “Coloring” represents the coloring ink applying step, and “Clear” represents the clear ink applying step.

From the results described above, it has been confirmed that the fabric printing method of the present invention can form an image having excellent wet friction color fastness.

According to the present invention, it is possible to provide a fabric printing method capable of forming an image having excellent wet friction color fastness, and a printed fabric on which an image having excellent wet friction color fastness is formed.

Details of the mechanism of exhibition or action of the effects of the present invention are not clear, but are assumed to be as below by the inventors of the present invention.

In the fabric printing method of the present invention, the coloring ink applying step, the clear ink applying step, and the coloring ink applying step are performed at least in this order, or the clear ink applying step, the coloring ink applying step, and the clear ink applying step are performed at least in this order. In this manner, the coloring agent contained in the coloring ink and the resin contained in the clear ink easily react or fuse with each other, and the coloring agent is easily fixed to the fabric by the resin. Therefore, in the fabric printing method of the present invention, the wet friction color fastness is improved as compared to the related art in which the coloring ink and the same type of clear ink are applied once each.

Although embodiments of the present invention have been described and illustrated in detail, the disclosed embodiments are made for purposes of illustration and example only and not limitation. The scope of the present invention should be interpreted by terms of the appended claims.

1. A fabric printing method comprising:
first coloring ink applying in which a coloring ink containing a coloring agent is applied to a fabric;
second clear ink applying in which a clear ink containing a resin is applied to the fabric so as to overlap with the coloring ink applied in the first coloring ink applying; and
third coloring ink applying in which the coloring ink containing the coloring agent is applied to the fabric so as to overlap with the clear ink applied in the second clear ink applying.

2. The fabric printing method according to claim 1, further comprising fourth clear ink applying in which the clear ink containing the resin is applied to the fabric so as to overlap with the coloring ink applied in the third coloring ink applying.

3. The fabric printing method according to claim 1, wherein,
the coloring ink applied in the first coloring ink applying and the coloring ink applied in the third coloring ink applying are the same coloring ink; and
the coloring ink is applied dividing an application amount between at least the first coloring ink applying and the third coloring ink applying.

4. The fabric printing method according to claim 2, wherein,
the clear ink applied in the second clear ink applying and the clear ink applied in the fourth clear ink applying are the same clear ink; and
the clear ink is applied dividing an application amount between at least the second clear ink applying and the fourth clear ink applying.

5. A fabric printing method comprising:
first clear ink applying in which a clear ink containing a resin is applied to a fabric;
second coloring ink applying in which coloring ink containing a coloring agent is applied to the fabric so as to overlap with the clear ink applied in the first clear ink applying; and
third clear ink applying in which the clear ink is applied to the fabric so as to overlap with the coloring ink applied in the second coloring ink applying.

6. The fabric printing method according to claim 5, further comprising fourth coloring ink applying in which the coloring ink containing the coloring agent is applied to the fabric so as to overlap with the clear ink applied in the third clear ink applying.

7. The fabric printing method according to claim 5, wherein the clear ink is applied dividing an application amount between at least the first clear ink applying and the third clear ink applying.

8. The fabric printing method according to claim 6, wherein,
the coloring ink applied in the second coloring ink applying and the coloring ink applied in the fourth coloring ink applying are the same coloring ink; and
the coloring ink is applied dividing an application amount between at least the second coloring ink applying and the fourth coloring ink applying.

9. A fabric printing method comprising:
coloring ink applying in which a coloring ink containing a coloring agent is applied to a fabric;
clear ink applying in which a clear ink containing a resin is applied to the fabric; and
performing one of the coloring ink applying or the clear ink applying, performing the other applying after the one applying, and performing the one applying again after the other applying so as to overlap the coloring ink and the clear ink.

10. The fabric printing method according to claim 9, wherein the application of the coloring ink and the application of the clear ink are performed wet-on-wet.

11. The fabric printing method according to claim 9, wherein the application of the coloring ink and the application of the clear ink are performed by an inkjet method.

12. The fabric printing method according to claim 1, wherein a content of the resin in any of the clear inks is within a range of 1 to 20% by mass.

13. The fabric printing method according to claim 5, wherein a content of the resin in any of the clear inks is within a range of 1 to 20% by mass.

14. The fabric printing method according to claim 9, wherein a content of the resin in any of the clear inks is within a range of 1 to 20% by mass.

15. The fabric printing method according to claim 9, further comprising applying a pretreatment liquid containing an aggregation agent.

16. The fabric printing method according to claim 15, wherein the aggregation agent is a water-soluble cationic resin.

17. The fabric printing method according to claim 9, wherein any of the clear inks contains a water-soluble cationic resin.

18. The fabric printing method according to claim 1, wherein any of the clear ink and any of the coloring ink has a viscosity in a range of 3 to 12 mPa·s at 25° C.

19. The fabric printing method according to claim 9, wherein any of the clear ink and any of the coloring ink has a viscosity in a range of 3 to 12 mPa·s at 25° C.

20. The fabric printing method according to claim 9, wherein any of the coloring inks contains the resin.
